(19) United States
(12) Patent Application Publication
(10) Pub. No.: US 2025/0121882 A1
(43) Pub. Date: Apr. 17, 2025

(54) METHOD FOR OPERATING A STEER-BY-WIRE STEERING SYSTEM OF A MOTOR VEHICLE, STEER-BY-WIRE STEERING SYSTEM AND MOTOR VEHICLE

(71) Applicant: AUDI AG, Ingolstadt (DE)

(72) Inventors: Sebastian LOOS, Ingolstadt (DE); Richard SCHROEDER, Ingolstadt (DE)

(73) Assignee: AUDI AG, Ingolstadt (DE)

(21) Appl. No.: 18/808,142

(22) Filed: Aug. 19, 2024

(30) Foreign Application Priority Data
Oct. 17, 2023 (DE) 102023128436.3

(51) Int. Cl. B62D 6/00

(52) U.S. Cl. CPC B62D 6/008

(57) ABSTRACT

A method for operating a steer-by-wire steering system of a motor vehicle, according to which a steering command entered via a steering handle is detected and a control signal for a steering gear actuator mechanically decoupled from the steering handle is generated therefrom by a regulation/control unit and according to which an actuation signal for an excitation of a force-feedback actuator assigned to the steering handle for applying haptic feedback signals on the steering handle is generated by the regulating/control unit. The method includes at least one natural frequency of the steering handle is determined, and the actuation signal to be generated by the regulation/control unit is adapted to the determined at least one natural frequency in such a way that excitations in the range of the natural frequency of the steering handle are prevented.

### FIELD

The invention relates to a method for operating a steer-by-wire steering system and a motor vehicle.

### BACKGROUND

Steer-by-wire steering systems are well known from the prior art and are characterized in particular by the fact that a steering column is not provided, i.e. the steering handle and the steering gear actuator are mechanically decoupled from each other and are controlled completely electronically via a force and travel control. For electronic regulation/control, the steering system has a regulation and control unit, which detects a steering request or steering command provided by the driver and generates a control signal from this to control the steering gear actuator. In order to provide the driver with haptic feedback, an electromechanical force feedback actuator is also assigned to the steering handle, which generates corresponding haptic feedback. The haptic feedback is a steering feedback, in which a steering counter-torque is applied to the steering handle depending on the steering forces occurring, and a road feedback, which correlates with a disturbance impulse acting on the vehicle on the road side. Reference is made to DE 10 2015 005 020 A1 by way of example only.

A generic method for operating a steer-by-wire steering system is disclosed in DE 10 2016 009 684 A1.

### SUMMARY

The object of the invention is to further develop a method for operating a steer-by-wire steering system of a motor vehicle in such a way that a vibration of the steering handle, which is perceived as unpleasant by the driver, is prevented.

According to the method for operating a steer-by-wire steering system, a steering command entered via a steering handle is detected in a known manner and a control signal is generated therefrom by means of a regulation/control unit for actuating a steering gear actuator mechanically decoupled from the steering handle. In addition, the regulation/control unit generates an actuation signal for causing a force feedback actuator assigned to the steering handle to apply haptic feedback to the steering handle.

According to the invention, it is now provided that at least one natural frequency of the steering handle is determined, and that the actuation signal to be generated by the regulation/control unit to actuate the force feedback actuator is adapted to the specific at least one natural frequency of the steering handle in such a way that when the haptic feedback signals are applied by the force feedback actuator, excitations which lie within the range of the natural frequency of the steering handle are omitted.

The method according to the invention now ensures in an advantageous way that—since excitations in the range of the natural frequency of the steering handle are omitted—the vibration of the steering handle is successfully prevented thus providing the driver with a comfortable driving experience.

A further advantage is that the method only requires a corresponding actuation of the force feedback actuator, i.e. a separate vibration damper for damping or preventing vibrations of the steering handle is not required.

A preferred method for this purpose is to detect the body vibrations of the vehicle body resulting from disturbances on the road side and/or the vehicle body side and to determine the excitation frequencies on which the body vibrations are based and to determine such excitation frequencies which lie in the range of the natural frequencies of the steering handle determined in advance.

A preferred embodiment of the invention is characterized by the fact that the thus determined excitation frequencies, i.e. the frequencies which lie in the range of the natural frequency of the steering handle, are filtered out so that they are not taken into account when generating the actuation signal or for generating the actuation signal for actuating the force feedback actuator. In other words, potential frequencies that promote vibrations of the steering handle are filtered out in advance, with the effect that the actuation signal does not have the corresponding frequencies. This advantageously ensures that the force feedback actuator only applies haptic feedback that is not in the range of the natural frequency of the steering handle, thus preventing the steering handle from vibrating.

Alternatively or in addition to the above embodiment, another embodiment of the method according to the invention provides that the actuation signal for actuating the force feedback actuator is generated taking into account the excitation frequencies determined in advance in such a way that by means of the force feedback actuator, excitations in the range of the natural frequency of the steering wheel handle are eliminated by applying oscillations the phase of which is opposite to the determined excitation frequencies. In other words, the force feedback actuator acts as a vibration damping device for damping frequencies in the range of the natural frequency of the steering wheel handle.

Preferably, the disturbance excitations of the vehicle body on the road side and/or vehicle body side are detected by means of sensors.

Another object of the invention is to provide a steer-by-wire steering system for a motor vehicle, which is designed—with little effort—to prevent undesired vibrations of the steering handle.

For this purpose, the steer-by-wire steering system comprises, in a known manner, a steering handle, a steering sensor for detecting a steering command provided at the steering handle, a steering gear actuator mechanically decoupled from the steering handle, a force feedback actuator associated with the steering handle and a regulation/control device, which is set up to generate a control signal for the steering gear actuator from the detected steering command and which is adapted to generate an actuation signal for the force feedback actuator for applying haptic feedback on the steering handle.

The steer-by-wire steering system according to the invention is characterized in that the regulation/control unit is furthermore adapted to carry out a method.

Since—as already explained—an undesired vibration of the steering handle is already prevented by carrying out the method according to the invention in a corresponding manner, in the steer-by-wire steering system according to the invention, further components, such as special steering wheel absorbers for absorbing or damping unwanted vibrations, are advantageously not required.

Another object of the invention is to further develop a motor vehicle which comprises a steer-by-wire steering system and at least one sensor for detecting disturbance excitations of the vehicle body on the road side and/or on the vehicle body side in such a way that the occurrence of undesirable vibrations of the steering handle is prevented during driving.

All of the explanations relating to the steer-by-wire steering system according to the invention and to the method according to the invention for operating the steer-by-wire steering system can be transferred analogously to the motor vehicle according to the invention, so that the aforementioned advantages can also be achieved with this vehicle.

Preferably, the at least one sensor is in the form of an acceleration sensor. Since corresponding sensors are normally installed in motor vehicles, this enables a cost-effective and low-cost implementation of the function “detection of disturbance excitations on the road side and/or on the vehicle body side”. However, it is also conceivable that the required disturbance excitation is determined by means of an estimator.

1. A method for operating a steer-by-wire steering system of a motor vehicle, according to which a steering command entered via a steering handle is detected and a control signal for a steering gear actuator mechanically decoupled from the steering handle is generated therefrom by a regulation/control unit and according to which an actuation signal for an excitation of a force-feedback actuator assigned to the steering handle for applying haptic feedback signals on the steering handle is generated by the regulating/control unit,
wherein at least one natural frequency of the steering handle is determined, and in that the actuation signal to be generated by means of the regulation/control unit is adapted to the determined at least one natural frequency in such a way that excitations in the range of the natural frequency of the steering handle are prevented.

2. The method according to claim 1, wherein disturbance excitations on the road side and/or on the vehicle body side and the resulting body vibrations of the vehicle body are detected and the excitation frequencies on which the body vibrations are based are determined, and such excitation frequencies which lie in the range of the natural frequency of the steering wheel, are determined.

3. The method according to claim 2, wherein the determined excitation frequencies are filtered out so that they are not taken into account when generating the actuation signal for the excitation of the force feedback actuator.

4. The method according to claim 2, wherein the actuation signal is generated taking into account the determined excitation frequencies in such a way that excitations in the range of the natural frequency of the steering handle are eliminated by the force feedback actuator on the steering wheel handle by applying vibrations in phase opposition to the determined excitation frequencies.

5. The method according to claim 2, wherein the road-side and/or vehicle body-side disturbance excitations of the vehicle body are detected by sensors.

6. A steer-by-wire steering system for a motor vehicle, comprising a steering handle, a steering sensor for detecting a steering command provided at the steering handle, a steering gear actuator mechanically decoupled from the steering handle, a force feedback actuator associated with the steering handle and a regulation/control device, which is set up to generate a control signal for the steering gear actuator from the detected steering command and which is set up to generate an actuation signal for the force feedback actuator for applying a haptic feedback on the steering handle, wherein the regulation and control device is furthermore adapted to carry out a method according to claim 1.

7. A motor vehicle, comprising a steer-by-wire steering system and at least one sensor for detecting disturbance excitations of the motor vehicle body on the road side and/or on the vehicle body side, wherein the steer-by-wire steering system is designed according to claim 6.

8. The motor vehicle according to claim 7, wherein the sensor is in the form of an acceleration sensor.
